(19) United States
(12) Patent Application Publication
(10) Pub. No.: US 2013/0128059 A1
(43) Pub. Date: May 23, 2013

(54) METHOD FOR SUPPORTING A USER TAKING A PHOTO WITH A MOBILE DEVICE

(71) Applicant: Andreas Kristensson, Sodra Sandby (SE)

(72) Inventor: Andreas Kristensson, Sodra Sandby (SE)

(73) Assignee: SONY MOBILE COMMUNICATIONS AB, Lund (SE)

(21) Appl. No.: 13/413,139

(22) Filed: Mar. 6, 2012

Related U.S. Application Data
(60) Provisional application No. 61/562,648, filed on Nov. 22, 2011.

(51) Int. Cl. H04N 5/225

(52) U.S. Cl. 348/207.1; 348/E05.024

(57) ABSTRACT

A method for supporting a user taking a photo with a mobile device and a system comprising a mobile device and a server are described.

### FIELD OF THE INVENTION

The present invention relates to a method for supporting a user taking a photo with a mobile device, and a system comprising a mobile device and a server performing the method.

### BACKGROUND OF THE INVENTION

Many mobile devices, for example mobile phones, smart phones, mobile navigation systems and mobile media players, comprise a camera for capturing images or videos. However, taking nicely composed pictures is an art.

Therefore, there is a need for supporting a user taking a photo with a mobile device such that nicely composed pictures may be obtained.

### SUMMARY OF THE INVENTION

According to an embodiment of the present invention, a method for supporting the user taking a photo with a mobile device is provided. According to the method, sensor information defining at least one parameter of the mobile device with respect to a photo scene in an environment of the mobile device is obtained. Based on the determined sensor information at least one photo capture setting is retrieved from a database. The at least one photo capture setting is output to the user.

According to an embodiment, determining the sensor information comprises determining a geographical position of the mobile device, determining a geographical direction in which an image capture unit of the mobile device is directed, or capturing an image of the environment in a direction in which the image capture unit of the mobile device is directed. Thus, from the sensor information it may be determined which photo scene the user wants to photograph. Based on this information improved photo capture settings may be retrieved from a database. The photo capture setting may comprise for example an image of the photo scene retrieved from the database, a position information for positioning the mobile device for taking a photo of the photo scene, a direction information for directing the user of the mobile device to move to a position for taking a photo of the photo scene, a time of the day information for taking a photo of the photo scene, or a weather information for taking a photo of the photo scene. By outputting these improved photo capture settings, the user may be guided to take an improved photo of the photo scene. For example, an image of the photo scene may be retrieved from the database and this image may be displayed on a display of the mobile device to the user. Thus, the user can adapt a viewing angle or a stand point for taking a photo of the photo scene. Furthermore, based on a current position of the mobile device and a position information of the image retrieved from the database, the user can be guided to a position which may be more appropriate for taking a photo of the photo scene. The guidance may comprise hints like “go to this location 200 m away on the map” or “move 30 m closer and aim a little bit higher”. Furthermore, the photo capture setting output to the user may comprise for example a hint like “take a photo preferably at 7 PM or during sunset”.

According to another embodiment, for retrieving the at least one photo capture setting the sensor information is transmitted from the mobile device to a server. Based on the sensor information the at least one photo capture setting is retrieved from a database of the server and the at least one photo capture setting is transmitted from the server to the mobile device. The server may comprise an Internet server having access to image databases in the Internet. Thus, images of the photo scene which have been already taken by other users and published in the Internet, may be used as a basis for retrieving the photo capture settings which are then transmitted to the mobile device and proposed to the user. For example, at least one photo may be retrieved from the database based on the determined sensor information. The at least one photo may be determined based on an algorithm comparing photos in the database with an image of the environment of the mobile device transmitted to the server. Furthermore, the at least one photo may be retrieved from the database based on the current geographical position of the mobile device and an additional information provided with the photos in the database indicating the geographical positions where the photos in the database have been captured.

According to a further embodiment, retrieving the at least one photo capture setting comprises retrieving a plurality of photos from the database based on the sensor information. Each of the retrieved photos comprises a rating, for example a rating of Internet users voting if they liked this photo or not. The at least one photo capture setting is determined based on the photo with the highest rating. Thus, the user may receive a guidance how to take a picture of the photo scene from a perspective or at those conditions that other people preferred.

According to yet another embodiment, a mobile device is provided comprising a sensor, an output unit, and a processing unit. The sensor provides in operation a sensor information defining at least one parameter of the mobile device with respect to a photo scene in an environment of the mobile device. The sensor may comprise for example a positioning sensor configured to determine a geographical position of the mobile device, a direction sensor configured to determine a geographical direction in which an image capture unit of the mobile device is directed, or an image capture unit configured to capture an image of the environment of the mobile device as the at least one parameter. The positioning sensor may comprise for example a GPS receiver for determining the geographical position based on GPS signals received from GPS satellites as it is known in the art. The direction sensor may comprise a compass determining a direction in which the image capture unit of the mobile device is directed based on the magnetic field of the earth. The image capture unit may comprise a so called CCD and a lens system as it is used in the art for generating digital images of an environment. The output unit may comprise for example a display, for example a liquid crystal display, for displaying images, graphical or textual information to a user of the mobile device. Furthermore, the output unit may comprise a loudspeaker for outputting audible information to a user, for example speech information. The processing unit is configured to retrieve at least one photo capture setting from a database based on the sensor information and to output the at least one photo capture setting to the user via the output unit.

The mobile device may comprise furthermore a transceiver unit for communicating with a server. The server is configured to retrieve the at least one photo capture setting from a database based on the sensor information. The processing unit is configured to transmit the sensor information to the server and to receive the at least one photo capture setting from the server. Thus, the mobile device gets access via the server to a large database of photo capture settings from which at least one photo capture setting is selected and output to the user supporting the user taking a photo with the mobile device.

The photo capture setting may comprise for example an image of the photo scene retrieved from the database, a position information for positioning the mobile device for taking a photo of the photo scene, a direction information for directing the user of the mobile device to move to a position for taking a photo of the photo scene, a time of the day information for taking a photo of the photo scene, or a weather information for taking a photo of the photo scene. Thus, a plurality of appropriate photo capture settings may be provided to the user to support the user in taking a photo of the photo scene.

The mobile device may comprise for example a mobile phone, a personal digital assistant, a mobile music player, a mobile computer, a mobile navigation system or a mobile camera. Especially a mobile phone or a so called smart phone is adapted, as these phones usually already comprise an image capture unit, a positioning sensor, a color display, a transceiver for communicating with a server, and a powerful processing unit.

According to another embodiment a server is provided comprising a transceiver unit for communicating with a mobile device, a database for storing a plurality of photos, and a processing unit. The processing unit is configured to receive sensor information from the mobile device. The sensor information defines at least one parameter of the mobile device with respect to a photo scene in an environment of the mobile device. Based on the received sensor information the processing unit retrieves a corresponding photo from the database. Based on the corresponding photo the processing unit generates at least one photo capture setting or retrieves at least one photo capture setting associated to the photo from the database. For example, by comparing a perspective of an image of the photo scene received as the sensor information from the mobile device with a perspective of a photo from the database the processing unit may calculate how the user of the mobile device has to move to reach a position from which a photo of the photo scene can be taken with a perspective comparable to the perspective of the photo from the database. This guidance information for guiding the user to a more appropriate position may be transmitted together with the photo from the database as the at least one photo capture setting to the mobile device.

According to another embodiment, a system comprising the above-described server and the above-described mobile device is provided.

Although specific features described in the above summary and the following detailed description are described in connection with specific embodiments, it is to be understood that the features of the embodiments may be combined with each other unless specifically noted otherwise. Furthermore, it is to be understood that the above-described features may be used independently from each other.

### BRIEF DESCRIPTION OF THE DRAWINGS

The invention will now be described in more detail with reference to the accompanying drawings.

FIG. 1 shows schematically a user taking a photo with a mobile device of a photo scene in an environment of the mobile device.

FIG. 2 shows schematically a system comprising a server and a mobile device according to an embodiment of the present invention.

FIG. 3 shows method steps of a method according to an embodiment of the present invention.

### DETAILED DESCRIPTION OF PREFERRED EMBODIMENTS

In the following, exemplary embodiments of the present invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments hereinafter.

It is to be understood that the features of the various exemplary embodiments described herein may be combined with each other unless specifically noted otherwise. Furthermore, any direct coupling of functional units or components in the embodiments shown in the Figures or described in the following detailed description may also be realized as an indirect coupling.

FIG. 1 shows a user 100 holding a mobile device 101 for taking a picture of a photo scene 102. The mobile device 101 may be a mobile phone or a so called smart phone comprising an image capture unit for capturing digital images and a display for displaying digital images and other information to the user 100. The mobile device 101 may comprise furthermore a positioning sensor for determining a geographical position of the mobile device based on for example positioning signals from satellites, for example GPS signals from GPS satellites, or based on positioning information from a telecommunication network. The mobile device 101 may furthermore comprise an electronic compass for determining a direction in which the mobile device 101 is directed, especially to determine a direction in which the image capture unit of the mobile device 101 is directed.

The photo scene 102 may comprise for example a church, a monument, a natural scene like mountains, a building, a bridge or any other points of interest.

The user 100 is located at a first position 103. From this first position 103 the user may take a photo of the photo scene 102 from a first perspective. However, other perspectives from other locations, for example from a location 104, may also be appropriate or may even be more appropriate for taking a photo of the photo scene 102. Therefore, the idea of the present invention is to tap into existing picture services and related crowd rating functionalities in the Internet and have the mobile device 101 guide the user 100 in how to take photos that may be better composed, may have nicer viewing angles, use the light in a better way and so on.

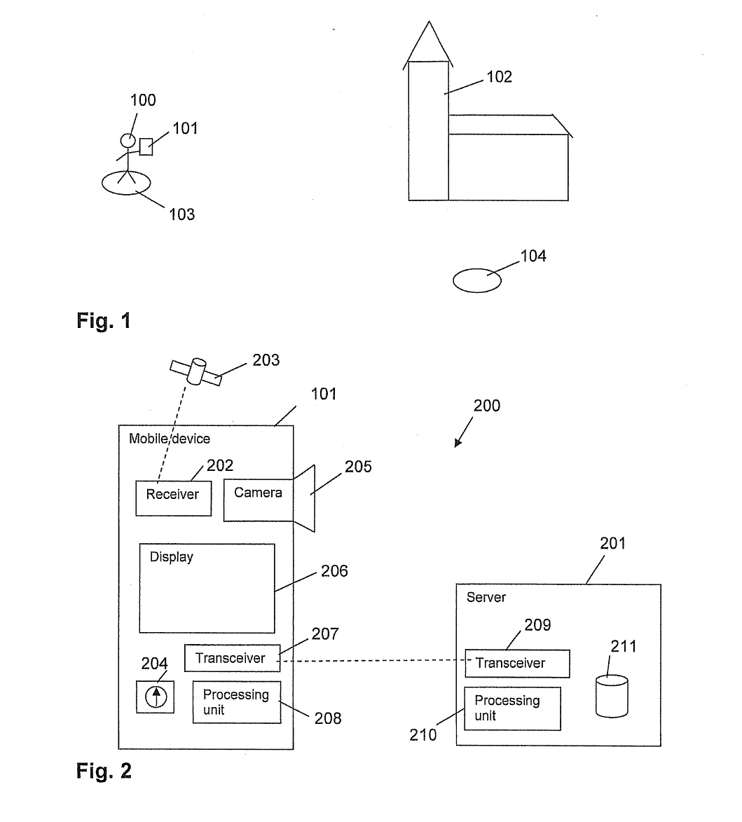

FIG. 2 shows a system 200 according to an embodiment of the present invention for supporting this idea. The system comprises the mobile device 101 and a server 201. The mobile device 101 comprises a positioning sensor 202 configured to determine a geographical position of the mobile device 101 based on signals from satellites 203, for example based on a GPS system. The mobile device 101 comprises furthermore a compass 204 configured to determine a geographical direction in which an image capture unit 205 of the mobile device 101 is directed. Furthermore, the mobile device 101 comprises a display 206, for example a liquid crystal color display, a transceiver unit 207 and a processing unit 208. The transceiver unit 207 is adapted to communicate with a transceiver unit 209 of the server 201. The server 201 comprises a processing unit 210 and a database 211. The database 211 may be a distributed database which is distributed over several servers and the processing unit 210 may be adapted to access the data from the distributed database.

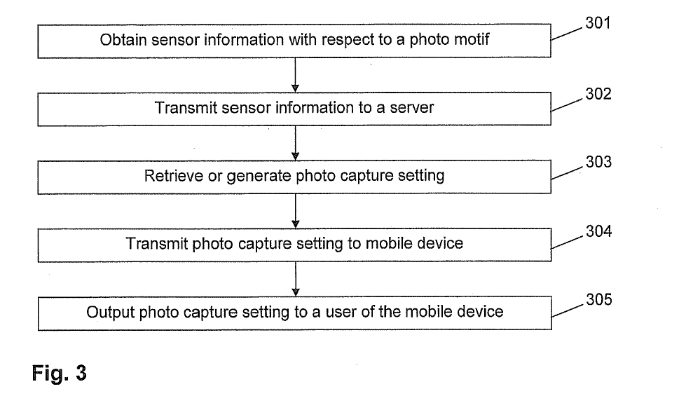

Operating of the system 200 will be described in more detail in connection with FIG. 3. By using sensor information of the mobile device 101 such as a GPS location from the positioning sensor 202, a direction information from the compass 204 and an image received by the image capture unit 205, the position and direction from where a picture is about to be taken may be obtained. These sensor information are obtained by the mobile device 101 in step 301. In step 302 the sensor information are transmitted to the server 201. Based on this sensor information the server 201 retrieves or generates photo capture settings in step 303. For example, the sensor information can be fed in real time into so called intelligent cloud services that instantaneously pick out related and highly rated pictures that are taken from the same location or closely nearby from existing picture services, for example by using the geographical position of the mobile device, the direction, an image analysis and user ratings. Based on the obtained pictures, photo capture settings indicating a better photographic angle or a better position for taking a photo may be calculated. The photo capture settings are transmitted to the mobile device in step 304 and output to the user 100 of the mobile device 101 in step 305. The photo capture settings may comprise also one or more pictures retrieved from the database which can then be provided to the user thus suggesting the user to consider other perspectives for taking a photo of the photo scene 102. For example, a picture retrieved from the database may be displayed overlaid or beside a current image captured by the image capturing unit 205 such that the user can easily compare different views of the photo scene 102. Furthermore, direction guidance may also be provided to the user 100 as to where to stand when taking the highly rated picture selected from the database. For example, a direction guidance information may be output as the photo capture setting to the user 100. This direction guidance may be supported by a map displayed on the display of the mobile device 101 indicating a current position 103 of the user 100 and a proposed position 104 for taking a better picture.

Weather and time of day could also be taken into account and derived from the most rated pictures as an indication to the user when a similar picture can be taken. Weather and time information may be stored together with photos of the scene 102 in the database 211 and output to the user 100 as the photo capture settings.

Finally, it is to be understood that all the embodiments described above are considered to be comprised by the present invention as it is defined by the appended claims.

1. A method for supporting a user taking a photo with a mobile device, the method comprising:
obtaining sensor information defining at least one parameter of the mobile device with respect to a photo scene in an environment of the mobile device,
retrieving at least one photo capture setting from a database based on the sensor information, and
outputting the at least one photo capture setting to the user.

2. The method according to claim 1, wherein retrieving the at least one photo capture setting comprises:
transmitting the sensor information from the mobile device to a server,
retrieving the at least one photo capture setting from a database of the server based on the sensor information, and
transmitting the at least one photo capture setting from the server to the mobile device.

3. The method according to claim 1, wherein retrieving the at least one photo capture setting comprises:
retrieving at least one photo from the database based on the sensor information, and
determining the at least one photo capture setting based on the at least one photo from the database.

4. The method according to claim 1, wherein retrieving the at least one photo capture setting comprises:
retrieving a plurality of photos from the database based on the sensor information, each of the retrieved photos comprising a rating, and
determining the at least one photo capture setting based on the photo with the highest rating.

5. The method according to claim 1, wherein determining the sensor information comprises at least one of a group comprising:
determining a geographical position of the mobile device,
determining a geographical direction in which an image capture unit of the mobile device is directed, and
capturing an image of the environment in a direction in which the image capture unit of the mobile device is directed.

6. The method according to claim 1, wherein the at least one photo capture setting comprises at least one of a group comprising:
an image of the photo scene retrieved from the database,
a position information for positioning the mobile device for taking a photo of the photo scene,
a direction information for directing the user of the mobile device to move to a position for taking a photo of the photo scene,
a time of the day information for taking a photo of the photo scene, and
a weather information for taking a photo of the photo scene.

7. A mobile device, comprising:
a sensor for providing a sensor information defining at least one parameter of the mobile device with respect to a photo scene in an environment of the mobile device,
an output unit for outputting information to a user of the mobile device, and
a processing unit configured to retrieve at least one photo capture setting from a database based on the sensor information and to output the at least one photo capture setting to the user via the output unit.

8. The mobile device according to claim 7, further comprising a transceiver unit for communicating with a server, the server being configured to retrieve the at least one photo capture setting from a database based on the sensor information, wherein the processing unit is configured to transmit the sensor information to the server, and to receive the at least one photo capture setting from the server.

9. The mobile device according to claim 7, wherein the sensor comprises at least one of a group comprising:
a positioning sensor configured to determine a geographical position of the mobile device,
a direction sensor configured to determine a geographical direction in which an image capture unit of the mobile device is directed, and
the image capture unit configured to capture an image of the environment of the mobile device as the at least one parameter.

10. The mobile device according to claim 7, wherein the at least one photo capture setting comprise at least one of a group comprising:
an image of the photo scene retrieved from the database,
a position information for positioning the mobile device for taking a photo of the photo scene,
a direction information for directing the user of the mobile device to move to a position for taking a photo of the photo scene,
a time of the day information for taking a photo of the photo scene, and
a weather information for taking a photo of the photo scene.

11. The mobile device according to claim 7, wherein the mobile device comprises at least one mobile device of a group comprising a mobile phone, a personal digital assistant, a mobile music player, a mobile computer, a mobile navigation system, and a mobile camera.

12. A server, comprising
a transceiver unit for communicating with a mobile device,
a database for storing a plurality of photos, and
a processing unit configured to retrieve a corresponding photo from the database based on sensor information received from the mobile device, the sensor information defining at least one parameter of the mobile device with respect to a photo scene in an environment of the mobile device, to generate at least one photo capture setting based on the corresponding photo or to retrieve at least one photo capture setting associated to the photo from the database, and to transmit the at least one photo capture setting to the mobile device.

13. A system comprising:
(a) a server comprising
a transceiver unit for communicating with a mobile device,
a database for storing a plurality of photos, and
a processing unit configured to retrieve a corresponding photo from the database based on sensor information received from the mobile device, the sensor information defining at least one parameter of the mobile device with respect to a photo scene in an environment of the mobile device, to generate at least one photo capture setting based on the corresponding photo or to retrieve at least one photo capture setting associated to the photo from the database, and to transmit the at least one photo capture setting to the mobile device, and
(b) a mobile device according to claim 7.
